(19) United States
(12) Patent Application Publication
(10) Pub. No.: US 2014/0270015 A1
(43) Pub. Date: Sep. 18, 2014

(54) INTER-CARRIER INTERFERENCE PHASE NOISE COMPENSATION BASED ON PHASE NOISE SPECTRUM APPROXIMATION

(71) Applicants: Vladimir Kravtsov, Jerusalem (IL); Michael Genossar, Modiin (IL); Alexey Khoryaev, Dzerzhinsk (RU); Artyom Lomayev, Nizhny Novgorod (RU)

(72) Inventors: Vladimir Kravtsov, Jerusalem (IL); Michael Genossar, Modiin (IL); Alexey Khoryaev, Dzerzhinsk (RU); Artyom Lomayev, Nizhny Novgorod (RU)

(21) Appl. No.: 13/996,793

(22) PCT Filed: Jun. 28, 2012
(86) PCT No.: PCT/RU12/00519

§ 371 Date: Apr. 14, 2014

(51) Int. Cl. H04B 1/12; H04L 27/148

(52) U.S. Cl. CPC H04B 1/12; H04L 27/148
USPC 375/343

(57) ABSTRACT

An approach is provided to compensate for inter-carrier interference caused by phase noise in a transmitted or received signal. The approach involves causing an estimation of one or more phase noise spectrum taps that cause inter-carrier interference in a received signal. The approach also involves causing an approximation of an instantaneous phase noise spectrum by a low order finite impulse response filter based on the estimated one or more phase noise spectrum taps. The approach additionally involves determining a de-convolution filter having two or more filter coefficients for one or more orthogonal frequency-division multiplexing symbols associated with the received signal. The approach further involves causing the de-convolution filter to be matched to the approximated instantaneous phase noise spectrum. The approach also involves causing the inter-carrier interference caused by phase noise to be compensated for based on a de-convolution procedure that applies the de-convolution filter to the one or more orthogonal frequency-division multiplexing symbols.

### BACKGROUND

Service providers and device manufacturers (e.g., wireless, cellular, etc.) are continually challenged to deliver value and convenience to consumers by, for example, providing compelling network services. Phase noise produced by commercial low-cost complementary metal-oxide-semiconductor (CMOS) based radio frequency integrated circuits (RFIC) in 60 GHz communication systems causes significant degradation of high-throughput modulation schemes (e.g. 16QAM, 64QAM), and thus puts significant constraints on a system's maximum throughput. Phase noise has two main effects on orthogonal frequency-division multiplexing (OFDM) systems: (1) the introduction of common phase error to OFDM data subcarriers, and (2) the injection of inter-carrier interference.

Conventional phase noise compensation methods are often implemented in OFDM devices, and compensate for only the common phase error discussed above. But, severe phase noise distortions often render conventional phase noise compensation methods insufficient.

### SOME EXAMPLE EMBODIMENTS

Therefore, there is a need for an approach to compensate for inter-carrier interference caused by phase noise in a transmitted or received signal.

According to one embodiment, a method comprises causing, at least in part, an estimation of one or more phase noise spectrum taps that cause inter-carrier interference in a received signal. The method also comprises causing, at least in part, an approximation of an instantaneous phase noise spectrum by a low order finite impulse response filter based, at least in part, on the estimated one or more phase noise spectrum taps. The method further comprises determining a de-convolution filter having two or more filter coefficients for one or more orthogonal frequency-division multiplexing symbols associated with the received signal. The method additionally comprises causing, at least in part, the de-convolution filter to be matched to the approximated instantaneous phase noise spectrum. The method also comprises causing, at least in part, the inter-carrier interference caused by phase noise to be compensated for based, at least in part, on a de-convolution procedure that applies the de-convolution filter to the one or more orthogonal frequency-division multiplexing symbols.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an estimation of one or more phase noise spectrum taps that cause inter-carrier interference in a received signal. The apparatus is also caused to cause, at least in part, an approximation of an instantaneous phase noise spectrum by a low order finite impulse response filter based, at least in part, on the estimated one or more phase noise spectrum taps. The apparatus is further caused to determine a de-convolution filter having two or more filter coefficients for one or more orthogonal frequency-division multiplexing symbols associated with the received signal. The apparatus is additionally caused to cause, at least in part, the de-convolution filter to be matched to the approximated instantaneous phase noise spectrum. The apparatus is further caused to cause, at least in part, the inter-carrier interference caused by phase noise to be compensated for based, at least in part, on a de-convolution procedure that applies the de-convolution filter to the one or more orthogonal frequency-division multiplexing symbols.

According to another embodiment, a method comprises causing, at least in part, an estimation of one or more phase noise spectrum taps that cause inter-carrier interference in a received signal. The method also comprises causing, at least in part, an approximation of an instantaneous phase noise spectrum by a low order finite impulse response filter based, at least in part, on the estimated one or more phase noise spectrum taps. The method further comprises causing, at least in part, the inter-carrier interference caused by phase noise to be compensated for based, at least in part, on a de-rotation procedure that multiplies one or more received orthogonal frequency-division multiplexing symbols on a conjugated inverse Discrete Fourier Transformation of the approximated instantaneous phase noise spectrum.

According to another embodiment, a computer-readable storage medium carries one or more sequences of one or more instructions which, when executed by one or more processors, cause, at least in part, an apparatus to cause, at least in part, an estimation of one or more phase noise spectrum taps that cause inter-carrier interference in a received signal. The apparatus is also caused to cause, at least in part, an approximation of an instantaneous phase noise spectrum by a low order finite impulse response filter based, at least in part, on the estimated one or more phase noise spectrum taps. The apparatus is further caused to determine a de-convolution filter having two or more filter coefficients for one or more orthogonal frequency-division multiplexing symbols associated with the received signal. The apparatus is additionally caused to cause, at least in part, the de-convolution filter to be matched to the approximated instantaneous phase noise spectrum. The apparatus is further caused to cause, at least in part, the inter-carrier interference caused by phase noise to be compensated for based, at least in part, on a de-convolution procedure that applies the de-convolution filter to the one or more orthogonal frequency-division multiplexing symbols.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments are illustrated by way of example, and not by way of limitation, in the figures of the accompanying drawings:

FIG. 1 is a diagram of a system capable of compensating for inter-carrier interference caused by phase noise in a transmitted or received signal, according to one embodiment;

FIG. 2 is a diagram of the components of a phase noise compensation platform configured to conduct a de-convolution procedure, according to one embodiment;

FIG. 3 is a diagram of the components of a phase noise compensation platform configured to conduct a de-rotation procedure, according to one embodiment;

FIG. 4 is a flowchart of a process to compensate for inter-carrier interference caused by phase noise in a transmitted or received signal by way of a de-convolution procedure according to one embodiment;

FIG. 5 is a flowchart of a process to compensate for inter-carrier interference caused by phase noise in a transmitted by way of a de-rotation procedure, according to one embodiment;

FIG. 6 is a graph illustrating a phase noise spectrum shape, according to one embodiment;

FIG. 7 is a graph illustrating residual phase noise power spectral density, according to one embodiment;

FIG. 8 is a graph illustrating conventional common phase error compensation in a Raleigh channel model;

FIG. 9 is a graph illustrating phase noise compensation including inter-carrier interference compensation by way of de-convolution, according to one embodiment; and

FIG. 10 is a diagram of a chip set that can be used to implement an embodiment.

### DESCRIPTION OF SOME EMBODIMENTS

Examples of a method, apparatus, and computer program to compensate for inter-carrier interference caused by phase noise in a transmitted or received signal are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

FIG. 1 is a diagram of a system capable of compensating for inter-carrier interference caused by phase noise in a transmitted or received signal, according to one embodiment. Phase noise produced by commercial low-cost complementary metal-oxide-semiconductor (CMOS) based radio frequency integrated circuits (RFIC) circuits in 60 GHz communication systems causes significant degradation of high-throughput modulation schemes (e.g. 16QAM, 64QAM), and thus puts significant constraints on a system's maximum throughput. Design of various digital signal processing methods that can be used to reduce the detrimental impact of phase noise are of high importance for further enhancement of 60 GHz practical implementations (e.g. IEEE802.1 lad and WiGig).

Phase noise has two main effects on orthogonal frequency-division multiplexing (OFDM) systems: (1) the introduction of common phase error to OFDM data subcarriers, and (2) the injection of inter-carrier interference.

Conventional phase noise compensation methods are often implemented in OFDM devices, and compensate for only the common phase error discussed above. But, severe phase noise distortions often render conventional phase noise compensation methods for high order modulations in 60 GHz systems. The throughput of a 60 GHz system may be limited by the inter-carrier interference caused by phase noise, and thus inter-carrier interference should be compensated for in addition to conventional common phase error compensation.

To address this problem, a system 100 of FIG. 1 introduces the capability of compensating for inter-carrier interference caused by phase noise in a transmitted or received signal.

As shown in FIG. 1, the system 100 comprises one or more user equipment (UE) 101a-101n (collectively referred to as UE 101) having connectivity to one or more a phase noise compensation platforms 103a-103n (collectively referred to as phase noise compensation platform 103) and one or more transmitters 107a-107n (collectively referred to as transmitter 107) via a communication network 105. In some embodiments, the phase noise compensation platform 103 may be a standalone component of the system 100 configured to communicate with one or more of the UE 101 and the transmitter 107, or it may be integrated into any of the UE 101 and/or the transmitter 107.

By way of example, the communication network 105 of system 100 includes one or more networks such as a wired data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), WiGig, wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one or more embodiments, the system 100 is configured to conduct phase noise inter-carrier interference compensation in OFDM based systems in application to a WiGig OFDM physical layer (OFDM PHY), for example. For example, a transmitted signal may be sent between any of the UE 101's and/or any of the transmitters 107. One UE 101 or transmitter 107 may be a transmitting side of the transmitted signal, while another UE 101 may be a receiving side of the transmitted signal, for example.

The phase noise compensation platform 103 uses one of a phase noise de-convolution technique in a frequency domain or a phase noise de-rotation technique in a time domain to compensate for, or cancel, phase noise. The phase noise compensation platform 103, for example approximates an instantaneous phase noise spectrum by a low order finite impulse response filter. In some embodiments, the phase noise compensation platform 103 also determines one or more closed form expressions for a phase noise de-convolution filter using one or more of a least squares or a weighted least squares error problem formulated for OFDM pilot signals.

In one or more embodiments, as discussed above, the inter-carrier interference solution may be used alone, or used in combination with a common phase error compensation technique or may be used in combination with a linear de-trending approach as well.

Phase noise is a multiplicative noise in a time domain. This means that in a frequency domain, the data and pilot subcarriers of a received OFDM symbol are cyclically convolved with the instantaneous phase noise spectrum of the phase noise time domain realization at both the transmitter and receiver sides of a transmitted signal. In order to compensate any phase noise distortion, the phase noise de-convolution filter is applied in the frequency domain. The phase noise de-convolution filter, according to various embodiments, has two or more determinable coefficients. To apply the phase noise de-convolution filter, the coefficients of its impulse response may be estimated. For example, in a simplified case, when phase noise is introduced at the receiver side of the transmitted signal, only the received OFDM signal in the frequency domain can be described by equation (1):

Rₖ=Σ₁₌₀^{N}^{_{OFDM}}⁻¹H₁X₁Jₖ₋₁+nₖ(1) (1)

In equation (1), X₁ is a transmitted signal at a subcarrier 1, H₁ is a channel coefficient for the subcarrier 1, Jₖ is an instantaneous phase noise spectrum coefficient for a given OFDM symbol, nₖ is an additive White Gaussian Noise value at a subcarrier k, and N_{OFDM} is the number of subcarriers in the OFDM symbol.

The typical form of the phase noise instantaneous spectrum has a dominant DC component that introduces the above-discussed common phase error. Several strong taps around the DC component causes inter-carrier interference. A limited number of strong taps around the DC component means that the phase noise spectrum can be approximated by a low order finite impulse response filter. As such, a solution for determining the de-convolution filter coefficients may be derived.

The phase noise spectrum is symmetrical in form around a DC subcarrier. The phase noise compensation platform 103 uses this property for estimating the de-convolution filter because the number of estimated parameters can be reduced twice, thereby increasing the accuracy of the estimation. The symmetrical property of the phase noise spectrum follows from the fact that phase noise is relatively small and can be approximated in a time domain as follows in equation (2):

exp(jφ(t))≈1+jφ(t) (2)

In equation 2, φ (t) is a real random phase noise process in time (e.g. phase noise trajectory). Due to the properties of Fourier Transforms, it can be shown that phase noise spectrum coefficients at the left and right sides around DC f=0 have the same image parts and their real parts have equal magnitudes and opposite signs.

In one or more embodiments, whether the phase noise spectrum is known, or estimated, the de-convolution filter can be represented by the matched filter solution provided as equation (3), for example:

MP(f)=J*(−f),J*(−f) [symbol] J(f)=δ(f) (3)

In equation 2, J(f) denotes the instantaneous phase noise spectrum realization, [symbol] denotes circular convolution, and δ(f) is a delta function. A proof that the matched filter does perfect de-convolution is based, for example, on the following considerations:

1. The product of exp(jφ(t))·exp(−jφ(t))=1 in the time domain is a constant value; and

2. In the frequency domain, it corresponds to circular convolution of the phase noise spectrum, and a flipped conjugated version of the phase noise spectrum FFT(|exp(jφ(t))|²)=J(f) [symbol] J*(−f)=δ(f) gives the delta function.

In one or more embodiments, the phase noise spectrum de-convolution filter coefficients can be measured at each OFDM symbol. For the following example, assume the phase noise spectrum is approximated well enough using three filter coefficients. It should be noted, however, that the filter coefficients may be of any number. As discussed above, the de-convolution filter has the form of the matched filter of the phase noise instantaneous spectrum. To estimate the matched de-convolution filter coefficients, a least squares problem or a weighted least squares problem may be formulated. In one or more embodiments, the least squares problem may be formulated based on the weighted least squares problem. Any error at known pilot subcarriers transmitted in OFDM signal spectrum may also be minimized. The phase noise de-convolution filter is matched to the phase instantaneous spectrum. For example, the weighted least squares problem may minimize, e.g., “−log” of the phase noise (i.e., a posteriori probability).

For example, to analytically formulate the problem:

$${Λ}^{2} = ( {λ}_{i}^{2} ) , i = 1 , … , \frac{1}{2} {N}_{OFDM}$$

is a residual single-side power spectrum density of the phase noise assuming that any common phase error and linear trend solution is removed.

N is a number such that the values of λ²ᵢ, i>N can be considered as negligible.

c=(cᵢ), i=1, . . . , is a “single-sided” vector of un-known phase noise spectrum tap coefficients that has to be measured for each OFDM symbol (normally distributed random variables with different variance values). These coefficients have the following properties:

c₋=−(cᵢ)*, cₒ=1, i≠o [symbol] cov(cᵢ, cⱼ)=0;

C=(cᵢ), i=−N, . . . , N are phase noise de-convolution filter coefficients;

Y=(Yₖ), k=1, . . . , N_{OFDM} is the received OFDM symbol (with removed common phase error and linear trend) in the frequency domain;

y^{C}=Y [symbol] C−convolution of Y and C; by definition, y^{C}=(y^{C})k=1, . . . , N_{OFDM};

S=(Sₖ), k=1, . . . , K is a vector of the pilot signals multiplied by the channel transfer function;

qₖ is the index of k^{th} pilot in the sequence of OFDM tones; and

σ² is the additive White Gaussian Noise (AWGN) power.

In these notations, the a priori probability distribution function of vector c is given by equation (4) (up to the scaling factor):

$$p ( c ) = exp ( - {\sum }_{i = 1}^{n} \frac{{\vert {c}_{i} \vert}^{2}}{2 {λ}_{1}^{2}} ) \qquad ( 4 )$$

The probability density function of S conditional on c is given by equation (5) (up to the scaling factor):

$$p ( S \vert c ) = exp ( - \frac{1}{2 {σ}^{2}} {\sum }_{k = 1}^{K} {\vert {y}_{{q}_{k}}^{c} - {s}_{k} \vert}^{2} ) \qquad ( 5 )$$

A new equation for determining the logarithm of a posteriori probability density function

$$L ( c \vert S ) = log ( \frac{p ( c ) P ( S \vert c )}{p ( S )} )$$

may be formulated by combining equations (4) and (5), thereby forming equation (6):

$$- 2 L ( c \vert S ) = \frac{1}{{σ}^{2}} {\sum }_{k = 1}^{K} {\vert {y}_{{q}_{k}}^{c} - {S}_{k} \vert}^{2} + {\sum }_{i = 1}^{n} \frac{{\vert {c}_{i} \vert}^{2}}{{λ}_{1}^{2}} + const \qquad ( 6 )$$

In equation (6), const is a constant that determines P(S) probability and the scaling factors discussed above in equations (4) and (5), and may be excluded from optimization problem on c coefficients.

$$+ {\sum }_{i = 1}^{n} \frac{{\vert {c}_{i} \vert}^{2}}{{λ}_{1}^{2}}$$

is a quadratic form that may be minimized to find an optimal solution to the weighted least squares problem discussed above. Also, as discussed above, it should be noted that the least squares problem can be formulated from the weighted least squares problem by not taking into account a priory probability of vector c, for example, by neglecting the knowledge of an average residual single-side power spectrum density Λ²=(λ²ᵢ).

In one or more embodiments, the phase noise compensation platform 103 resolves the formulated weighted least squares and/or least squares problems by way of a closed form expression to estimate the de-convolution filter coefficients discussed above. Once the de-convolution filter coefficients are calculated, a de-convolution procedure with the received signal spectrum in the frequency domain is applied by the phase noise compensation platform 103 to compensate for the inter-carrier interference. Alternatively, if phase noise is compensated for in the time domain, the realization of the phase noise spectrum, discussed above, may be applied to compensate for the inter-carrier interference. For example, a de-rotation procedure that multiplies one or more received orthogonal frequency-division multiplexing symbols on a conjugated inverse Discrete Fourier Transformation of the approximated instantaneous phase noise spectrum may be conducted by the phase noise compensation platform 103.

According to various embodiments, the system 100 cancels phase noise inter-carrier interference (ICI). In that sense, the phase noise cancellation solution applied by the system 100 differs from at least conventional baseline solutions applied in low-carrier frequency communication systems that merely compensate for only common phase error, The system 100 also has practical implementation complexity and applies closed form expressions that exist to directly calculate coefficients of the phase noise de-convolution filter, discussed above, unlike conventional decision-aided solutions for compensating for phase noise.

In one or more embodiments, the system 100 is less sensitive to increase in phase noise power when compared to conventional common phase error phase noise compensation techniques, and has some practical performance margins in that sense that allow for high-throughput transmission in phase noise limited systems. Additionally, in some embodiments, the system 100 does not require specification changes and can be implemented in existing IEEE 802.11ad/WiGig specifications (e.g., the IEEE 802.11 standard, IEEE std. 802.11.2012, published Mar. 29, 2012)/(Wireless Gigabit Alliance, WiGig White Paper, published 2010) without requiring assistance from the transmission side of a transmitted signal.

In embodiments in which the weighted least squares problems are applied, the system 100 exploits a priori information of average phase noise power spectrum density that can be practically measured and used to improve accuracy of the instantaneous phase noise spectrum measurements.

By way of example, the UE 101, phase noise compensation platform 103, and transmitter 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 2 is a diagram of the components of the phase noise compensation platform 103 according to one embodiment. In this embodiment, the phase noise compensation platform 103 is configured to compensate for phase noise by way of the de-convolution technique, discussed above. By way of example, the phase noise compensation platform 103 includes one or more components for compensating for inter-carrier interference caused by phase noise in a transmitted or received signal. It is contemplated that the functions of these components may be combined in one or more components or performed by other components of equivalent functionality. In this embodiment, the phase noise compensation platform 103 includes a communication module 201 that is associated with an RF chain and an antenna of receivers such as UE 101, for example. The phase noise compensation platform 103 also includes an analog to digital converter module (ADC) 203, a cyclical prefix (CP) removal module 205, a Fast Fourier Transform (FFT) module 207, a serial to parallel (S/P) module 209, a channel estimator module 211, a pilot subcarrier extractor module 213, a phase noise spectrum estimator module 215, a phase noise de-convolution module 217, a quadrature amplitude modulation (QAM) module 219, and a forward error correction (FEC) module 221.

According to various embodiments, the communication module 201 received an orthogonal frequency-division multiplexing signal, the ADC 203 converts the received signal from an analog waveform to a digital signal. Then the CP removal module 205 processes the digital signal to prepare the signal for the FFT module 207. The FFT module 207 conducts the FFT discussed above. The S/P module 209 processes the output of the FFT module 207 and indicates the output to the phase noise de-convolution module 217. Meanwhile, the channel estimator module 211 estimates channel state information of the receiver (e.g. UE 101) and provides the estimation to the pilot subcarrier extractor module 213, The pilot subcarrier extractor module 213 processes the output of the S/P module 209 and may consider the output of the channel estimator module 211 to determine one or more pilot subcarriers transmitted in the received orthogonal frequency-division multiplexing signal. Then, the phase noise spectrum estimator module 215 estimates one or more phase noise spectrum taps that cause inter-carrier interference in the received signal and approximates an instantaneous phase noise spectrum based, at least in part, on the phase noise spectrum taps.

Next, the phase noise de-convolution module 217 determines a de-convolution filter having two or more filter coefficients for one or more orthogonal frequency-division multiplexing symbols associated with the received signal. Then, the phase noise de-convolution module 217 causes, at least in part, the de-convolution filter to be matched to the approximated instantaneous phase noise spectrum, and causes, at least in part, the inter-carrier interference caused by phase noise to be compensated for based, at least in part, on a de-convolution procedure that applies the de-convolution filter to the one or more orthogonal frequency-division multiplexing symbols.

The received signal having been processed to compensate for phase noise is processed by the QAM demapping module 219, and then processed by the FEC module 221 for error correction and output.

FIG. 3 is a diagram of the components of the phase noise compensation platform 103 according to one embodiment. In this embodiment, the phase noise compensation platform 103 is configured to compensate for phase noise by way of the de-rotation technique, discussed above. By way of example, the phase noise compensation platform 103 includes one or more components for compensating for inter-carrier interference caused by phase noise in a transmitted or received signal. It is contemplated that the functions of these components may be combined in one or more components or performed by other components of equivalent functionality. In this embodiment, the phase noise compensation platform 103 includes a communication module 301 that is associated with an RF chain and an antenna of receivers such as UE 101, for example. The phase noise compensation platform 103 also includes an analog to digital converter module (ADC) 303, a cyclical prefix (CP) removal module 305, a phase noise compensator module 307, a Fast Fourier Transform (FFT) module 309, a serial to parallel (SIP) module 311, a pilot subcarrier extractor module 313, a channel estimator module 215, a phase noise spectrum estimator module 317, an Inverse Fast Fourier Transform (IFFT) module 319, a quadrature amplitude modulation (QAM) module 321, and a forward error correction (FEC) module 323.

According to various embodiments, the communication module 301 received an orthogonal frequency-division multiplexing signal, the ADC 303 converts the received signal from an analog waveform to a digital signal. Then the CP removal module 305 processes the digital signal to prepare the signal for the FFT module 309 and the phase noise compensator module 307. The phase noise compensator module 307 determines whether the received signal is ready to be compensated for phase noise, or if the received signal needs to be subjected to the de-rotation procedure discussed above. The FFT module 309 conducts the FFT discussed above. The S/P module 311 processes the output of the FFT module 309. The pilot subcarrier extractor module processes the output of the S/P module 209 to determine one or more pilot subcarriers transmitted in the received orthogonal frequency-division multiplexing signal. Meanwhile, the channel estimator module 315 estimates channel state information of the receiver (e.g. UE 101) and provides the estimation to the phase noise spectrum estimator 317. Then, the phase noise spectrum estimator module 317 estimates one or more phase noise spectrum taps that cause inter-carrier interference in the received signal and approximates an instantaneous phase noise spectrum based, at least in part, on the phase noise spectrum taps.

Next, the IFFT module 319 subjects the received signal having been processed by the preceding modules to an IFFT. The phase noise compensator module 307 then determines that the processed signal is ready for phase noise compensation based on the output of the IFFT module 319 which conducts the IFFT of the approximated instantaneous phase noise spectrum. The FFT module 309 then conducts another FFT of the signal having been processed by the preceding modules and subjected to the IFFT, and the S/P module 311 processes the output of the FFT module 309. The received signal having been processed to compensate for phase noise is processed by the QAM demapping module 219, and then processed by the FEC module 221 for error correction and output.

FIG. 4 is a flowchart of a process to compensate for inter-carrier interference caused by phase noise in a transmitted or received signal, according to one embodiment. In one embodiment, the phase noise compensation platform 103 performs the process 400 and is implemented in, for instance, a chip set including a processor and a memory as shown in FIG. 10. In step 401, the phase noise compensation platform 103 estimates one or more phase noise spectrum taps that cause inter-carrier interference in a received signal communicated between any of the UE 101's, discussed above, and/or the transmitters 107. Next, in step 403, the phase noise compensation platform 103 causes, at least in part, an instantaneous phase noise spectrum to be approximated by a low order finite impulse response filter. According to various embodiments, the instantaneous phase noise spectrum is approximated in a frequency domain.

Then, in step 405, the phase noise compensation platform 103 determines a de-convolution filter having one or more filter coefficients for one or more orthogonal frequency-division multiplexing symbols associated with the received signal. In one or more embodiments, the de-convolution filter comprises three or more filter coefficients, but it should be noted that the de-convolution filter may comprise any number of filter coefficients.

According to various embodiments, the phase noise compensation platform 103 may cause, at least in part, a least squares error problem for an orthogonal frequency-division multiplexing pilot signal to be formulated, and cause, at least in part, the one or more filter coefficients to be estimated based, at least in part, on a solution of the least squares error problem. Alternatively, the phase noise compensation platform 103 may cause, at least in part, a weighted least squares error problem for an orthogonal frequency-division multiplexing pilot signal to be formulated, and cause, at least in part, the one or more filter coefficients to be estimated based, at least in part, on a solution of the weighted least squares error problem. Or, the phase noise compensation platform 103 may cause, at least in part, a weighted least squares error problem for an orthogonal frequency-division multiplexing pilot signal to be formulated, cause, at least in part, a least squares error problem for an orthogonal frequency-division multiplexing pilot signal to be formulated based, at least in part, on the weighted lease squares error problem, and cause, at least in part, the one or more filter coefficients to be estimated based, at least in part, on a solution of the least squares error problem. According to various embodiments, the de-convolution filter is based, at least in part, on a matched filter solution.

In solving the weighted least squares error problem and/or the least squares error problem, the phase noise compensation platform 103 determines one or more pilot subcarriers transmitted in an orthogonal frequency-division multiplexing signal, and causes, at least in part, an error in the one or more pilot subcarriers to be minimized.

Next, in step 407, the phase noise compensation platform 103 causes, at least in part, the de-convolution filter to be matched to the instantaneous phase noise spectrum. The process continues to step 409 in which the phase noise compensation platform 103 causes, at least in part, the one or more instances of inter-carrier interference caused by phase noise to be compensated for based, at least in part, on a de-convolution procedure that applies the de-convolution filter. According to various embodiments, the phase noise compensation platform 103 may cause, at least in part, the phase noise to be compensated for by combining the de-convolution procedure with a common phase error technique, or with a linear phase de-trending technique to further reduce or eliminate the existence of phase noise in the received signal.

FIG. 5 is a flowchart of a process to compensate for inter-carrier interference caused by phase noise in a transmitted or received signal, according to one embodiment. In one embodiment, the phase noise compensation platform 103 performs the process 500 and is implemented in, for instance, a chip set including a processor and a memory as shown in FIG. 10. In step 501, the phase noise compensation platform 103 estimates one or more phase noise spectrum taps that cause inter-carrier interference in a received signal communicated between any of the UE 101's, discussed above, and/or the transmitters 107. Next, in step 503, the phase noise compensation platform 103 causes, at least in part, an instantaneous phase noise spectrum to be approximated by a low order finite impulse response filter. According to various embodiments, the instantaneous phase noise realization is approximated in a time domain.

Next, in step 505, the phase noise compensation platform 103 causes, the approximated phase noise spectrum to be converted to an instantaneous phase noise realization based, at least in part, on a conjugated inverse Discrete Fourier Transformation. Then, in step 507, the phase noise compensation platform 103 causes, at least in part, the inter-carrier interference caused by phase noise to be compensated for based, at least in part, on a de-rotation procedure that multiplies one or more received orthogonal frequency-division multiplexing symbols on the conjugated inverse Discrete Fourier Transformation of the approximated instantaneous phase noise spectrum.

FIG. 6 is a graph illustrating the typical form of phase noise instantaneous spectrum magnitude. The typical form of the phase noise instantaneous spectrum has a dominant DC component 601 which introduces the above-discussed common phase error, and several strong taps around the DC that cause inter-carrier interference. A limited number of strong taps 603 around the DC component 601 practically means that the phase noise spectrum can be approximated by a low order finite impulse response filter. This concept may be used to derive a solution for determining the de-convolution filter coefficients.

FIG. 7 is a graph illustrating the residual phase noise power spectral density after common phase error compensation, linear de-trending, and de-convolution in an example simulation. The performance of the system 100 provides residual power spectral density (PSD) 701 of phase noise (PN) after common phase error (CPE) compensation 703, common phase error with linear de-trending (LDT) 705, common phase error compensation with de-convolution 707 conducted by the phase noise compensation platform 103, and common phase error compensation with linear de-trending and de-convolution 709 conducted by the phase noise compensation platform 103. It can be seen that the phase noise compensation platform 103 offers superior performance in terms of phase noise cancellation over the other techniques that exclude de-convolution.

FIG. 8 illustrates a graph of another performance measure for phase noise compensation in an example simulation. FIG. 8 illustrates the Packet Error Rate (PER) for WiGig system. FIG. 8 shows PER vs. SNR (simulated not real) simulation results for a frequency selective Rayleigh channel model for ideal performance without phase noise and performance in presence of phase noise after common phase error (CPE) compensation. As it can be seen from FIG. 8, common phase error compensation is insufficient for reliable WiGig transmission at high data rates in the presence of phase noise distortion. Accordingly, advanced methods for inter-carrier interference compensation are needed, as discussed above, to better compensate for phase noise over conventional methods. The PER vs. SNR simulation results 801 in Rayleigh channel for WiGig high order modulations differentiates ideal performance from performance in the presence of phase noise with common phase error compensation as follows for various modulations and coding rates 803. For example, a solid line for a particular modulation and coding rate 803 indicates an ideal performance without phase noise, and a dotted line for a particular modulation and coding rate 803 indicates performance in the presence of phase noise common phase error compensation.

FIG. 9 is a graph illustrating PER vs. SNR simulation results 901 for a frequency selective Rayleigh channel model and various modulation and coding rates 903, similar to that discussed above in FIG. 8, for ideal performance without phase noise and performance in the presence of phase noise after compensation applying the de-convolution based method discussed above.

In FIG. 9, the PER s. SNR simulation results in a Rayleigh channel for WiGig high order modulations. A solid line indicates an ideal performance without phase noise, a dashed line indicates performance in the presence of phase noise compensation with the de-convolution method, as performed by the phase noise compensation platform 103, discussed above, and a dotted line indicates the performance in the presence of phase noise with increased phase noise power spectral density by 3 dB, and compensation with the de-convolution method performed by the phase noise compensation platform 103.

As illustrated, the performance of the de-convolution based method for phase noise (PN) cancellation does not deteriorate significantly even when power spectral density is increased by 3 dB at each side (transmitter 107 and receiver (UE 101), for example). This can be explained by the fact that major inter-carrier interference comes from an adjacent subcarrier, and three de-convolution coefficients are sufficient, in this example, to compensate the main inter-carrier interference effect caused by phase noise (PN).

The processes described herein for to compensate for inter-carrier interference caused by phase noise in a transmitted or received signal may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 10 illustrates a chip set or chip 1000 upon which an embodiment may be implemented. Chip set 1000 is programmed to compensate for inter-carrier interference caused by phase noise in a transmitted or received signal as described herein may include, for example, bus 1001, processor 1003, memory 1005, DSP 1007 and ASIC 1009 components.

The processor 1003 and memory 1005 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of compensating for inter-carrier interference caused by phase noise in a transmitted or received signal.

In one or more embodiments, the chip set or chip 1000 includes a communication mechanism such as bus 1001 for passing information among the components of the chip set 1000. Processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one or more embodiments, the processor (or multiple processors) 1003 performs a set of operations on information as specified by computer program code related to compensating for inter-carrier interference caused by phase noise in a transmitted or received signal. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1001 and placing information on the bus 1001. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1003, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 1003 and accompanying components have connectivity to the memory 1005 via the bus 1001. The memory 1005 may include one or more of dynamic memory (e.g., RAM, magnetic disk, writable optical disk, etc.) and static memory (e.g., ROM, CD-ROM, etc.) for storing executable instructions that when executed perform the inventive steps described herein to compensate for inter-carrier interference caused by phase noise in a transmitted or received signal. The memory 1005 also stores the data associated with or generated by the execution of the inventive steps.

In one or more embodiments, the memory 1005, such as a random access memory (RAM) or any other dynamic storage device, stores information including processor instructions for compensating for inter-carrier interference caused by phase noise in a transmitted or received signal. Dynamic memory allows information stored therein to be changed by system 100. RAM allows a unit of information stored at a location called a memory address to be stored and retrieved independently of information at neighboring addresses. The memory 1005 is also used by the processor 1003 to store temporary values during execution of processor instructions. The memory 1005 may also be a read only memory (ROM) or any other static storage device coupled to the bus 1001 for storing static information, including instructions, that is not changed by the system 100. Some memory is composed of volatile storage that loses the information stored thereon when power is lost. The memory 1005 may also be a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 1003, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the disclosure is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method comprising:
causing, at least in part, an estimation of one or more phase noise spectrum taps that cause inter-carrier interference in a received signal;
causing, at least in part, an approximation of an instantaneous phase noise spectrum by a low order finite impulse response filter based, at least in part, on the estimated one or more phase noise spectrum taps;
determining a de-convolution filter having two or more filter coefficients for one or more orthogonal frequency-division multiplexing symbols associated with the received signal;
causing, at least in part, the de-convolution filter to be matched to the approximated instantaneous phase noise spectrum; and
causing, at least in part, the inter-carrier interference caused by phase noise to be compensated for based, at least in part, on a de-convolution procedure that applies the de-convolution filter to the one or more orthogonal frequency-division multiplexing symbols.

2. A method of claim 1, wherein the de-convolution filter comprises three or more filter coefficients.

3. A method of claim 1, further comprising:
causing, at least in part, a least squares error problem for an orthogonal frequency-division multiplexing pilot signal to be formulated; and
causing, at least in part, the two or more filter coefficients to be estimated based, at least in part, on a solution of the least squares error problem.

4. A method of claim 1, further comprising:
causing, at least in part, a weighted least squares error problem for an orthogonal frequency-division multiplexing pilot signal to be formulated; and
causing, at least in part, the two or more filter coefficients to be estimated based, at least in part, on a solution of the weighted least squares error problem.

5. A method of claim 1, further comprising:
causing, at least in part, a weighted least squares error problem for an orthogonal frequency-division multiplexing pilot signal to be formulated;
causing, at least in part, a least squares error problem for an orthogonal frequency-division multiplexing pilot signal to be formulated based, at least in part, on the weighted least squares error problem; and
causing, at least in part, the two or more filter coefficients to be estimated based, at least in part, on a solution of the least squares error problem.

6. A method of claim 1, further comprising:
causing, at least in part, the phase noise to be compensated for by combining the de-convolution procedure with a common phase error technique.

7. A method of claim 1, further comprising:
causing, at least in part, the phase noise to be compensated for by combining the de-convolution procedure with a linear phase de-trending technique.

8. A method of claim 1, wherein the approximation of the instantaneous phase noise spectrum is in a frequency domain.

9. A method of claim 1, wherein the de-convolution filter is based, at least in part, on a matched filter solution.

10. A method of claim 1, further comprising:
determining one or more pilot subcarriers transmitted in an orthogonal frequency-division multiplexing signal; and
causing, at least in part, an error in the one or more pilot subcarriers to be minimized.

11. An apparatus comprising:
at least one processor; and
at least one memory including computer program code for one or more programs,
the at least one memory and the computer program code configured to, with the at least one processor, cause the apparatus to perform at least the following,
cause, at least in part, an estimation of one or more phase noise spectrum taps that cause inter-carrier interference in a received signal;
cause, at least in part, an approximation of an instantaneous phase noise spectrum by a low order finite impulse response filter based, at least in part, on the estimated one or more phase noise spectrum taps;
determine a de-convolution filter having two or more filter coefficients for one or more orthogonal frequency-division multiplexing symbols associated with the received signal;
cause, at least in part, the de-convolution filter to be matched to the approximated instantaneous phase noise spectrum; and
cause, at least in part, the inter-carrier interference caused by phase noise to be compensated for based, at least in part, on a de-convolution procedure that applies the de-convolution filter to the one or more orthogonal frequency-division multiplexing symbols.

12. An apparatus of claim 11, wherein the de-convolution filter comprises three or more filter coefficients.

13. An apparatus of claim 11, wherein the apparatus is further caused to:
cause, at least in part, a least squares error problem for an orthogonal frequency-division multiplexing pilot signal to be formulated; and
cause, at least in part, the two or more filter coefficients to be estimated based, at least in part, on a solution of the least squares error problem.

14. An apparatus of claim 11, wherein the apparatus is further caused to:
cause, at least in part, a weighted least squares error problem for an orthogonal frequency-division multiplexing pilot signal to be formulated; and
cause, at least in part, the two or more filter coefficients to be estimated based, at least in part, on a solution of the weighted least squares error problem.

15. An apparatus of claim 11, wherein the apparatus is further caused to:
cause, at least in part, a weighted least squares error problem for an orthogonal frequency-division multiplexing pilot signal to be formulated;
cause, at least in part, a least squares error problem for an orthogonal frequency-division multiplexing pilot signal to be formulated based, at least in part, on the weighted least squares error problem; and
cause, at least in part, the two or more filter coefficients to be estimated based, at least in part, on a solution of the least squares error problem.

16. An apparatus of claim 11, wherein the apparatus is further caused to:
cause, at least in part, the phase noise to be compensated for by combining the de-convolution procedure with a common phase error technique.

17. An apparatus of claim 11I, wherein the apparatus is further caused to:
cause, at least in part, the phase noise to be compensated for by combining the de-convolution procedure with a linear phase de-trending technique.

18. An apparatus of claim 11, wherein the approximation of the instantaneous phase noise spectrum is in a frequency domain.

19. An apparatus of claim 11, wherein the de-convolution filter is based, at least in part, on a matched filter solution.

20. An apparatus of claim 11, wherein the apparatus is further caused to:
determine one or more pilot subcarriers transmitted in an orthogonal frequency-division multiplexing signal; and
cause, at least in part, an error in the one or more pilot subcarriers to be minimized.

21. A method comprising:
causing, at least in part, an estimation of one or more phase noise spectrum taps that cause inter-carrier interference in a received signal;
causing, at least in part, an approximation of an instantaneous phase noise spectrum by a low order finite impulse response filter based, at least in part, on the estimated one or more phase noise spectrum taps; and
causing, at least in part, the inter-carrier interference caused by phase noise to be compensated for based, at least in part, on a de-rotation procedure that multiplies one or more received orthogonal frequency-division multiplexing symbols on a conjugated inverse Discrete Fourier Transformation of the approximated instantaneous phase noise spectrum.

22. A method of claim 21, further comprising:
causing, at least in part, the approximated phase noise spectrum to be converted to an instantaneous phase noise realization based, at least in part, on the conjugated inverse Discrete Fourier Transformation.

23. A method of claim 22, wherein the instantaneous phase noise realization is approximated in a time domain.

24. A method of claim 21, further comprising:
determining one or more pilot subcarriers transmitted in an orthogonal frequency-division multiplexing signal; and
causing, at least in part, an error in the one or more pilot subcarriers to be minimized.

25. A computer-readable storage medium carrying one or more sequences of one or more instructions which, when executed by one or more processors, cause an apparatus to:
cause, at least in part, an estimation of one or more phase noise spectrum taps that cause inter-carrier interference in a received signal;
cause, at least in part, an approximation of an instantaneous phase noise spectrum by a low order finite impulse response filter based, at least in part, on the estimated one or more phase noise spectrum taps;
determine a de-convolution filter having two or more filter coefficients for one or more orthogonal frequency-division multiplexing symbols associated with the received signal;
cause, at least in part, the de-convolution filter to be matched to the approximated instantaneous phase noise spectrum; and
cause, at least in part, the inter-carrier interference caused by phase noise to be compensated for based, at least in part, on a de-convolution procedure that applies the de-convolution filter to the one or more orthogonal frequency-division multiplexing symbols.

26. A computer-readable storage medium of claim 25, wherein the apparatus is further caused to:
cause, at least in part, a least squares error problem for an orthogonal frequency-division multiplexing pilot signal to be formulated; and
cause, at least in part, the two or more filter coefficients to be estimated based, at least in part, on a solution of the least squares error problem.

27. A computer-readable storage medium of claim 25, wherein the apparatus is further caused to:
cause, at least in part, a weighted least squares error problem for an orthogonal frequency-division multiplexing pilot signal to be formulated; and
cause, at least in part, the two or more filter coefficients to be estimated based, at least in part, on a solution of the weighted least squares error problem.

28. A computer-readable storage medium of claim 25, wherein the apparatus is further caused to:
cause, at least in part, a weighted least squares error problem for an orthogonal frequency-division multiplexing pilot signal to be formulated;
cause, at least in part, a least squares error problem for an orthogonal frequency-division multiplexing pilot signal to be formulated based, at least in part, on the weighted least squares error problem; and
cause, at least in part, the two or more filter coefficients to be estimated based, at least in part, on a solution of the least squares error problem.

29. A computer-readable storage medium of claim 25, wherein the apparatus is further caused to:
cause, at least in part, the phase noise to be compensated for by combining the de-convolution procedure with a common phase error technique.

30. A computer-readable storage medium of claim 25, wherein the apparatus is further caused to:
cause, at least in part, the phase noise to be compensated for by combining the de-convolution procedure with a linear phase de-trending technique.
